(19) United States
(12) Patent Application Publication
(10) Pub. No.: US 2010/0150247 A1
(43) Pub. Date: Jun. 17, 2010

(54) VIDEO PROCESSING APPARATUS FOR PROCESSING PLURALITY OF MULTIMEDIA, VIDEO PROCESSING METHOD APPLIED TO THE SAME, RECORDING MEDIUM, AND DISPLAY APPARATUS

(75) Inventor: Ho-seon KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/625,168

(22) Filed: Nov. 24, 2009

(30) Foreign Application Priority Data
Dec. 16, 2008 (KR) 10-2008-0127856

(51) Int. Cl. H04N 7/26

(52) U.S. Cl. 375/240.25; 375/E07.027

(57) ABSTRACT

A video processing apparatus and a video processing method are provided. A scheduler determines an order for alternatively decoding each of a plurality of videos which are concurrently input, in a unit of a predetermined amount. A multi-codec alternatively decodes each of the videos in the unit of the predetermined amount in the determined decoding order.

### CROSS-REFERENCE TO RELATED APPLICATIONS

This application claims priority from Korean Patent Application No. 10-2008-0127856, filed Dec. 16, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to video processing, and more particularly, to encoding or decoding videos of various formats.

2. Description of the Related Art

The term “codec”, which is a portmanteau of “coder” and “decoder”, refers to a device or software which encodes or decodes audio or video data. The codec converts audio or video data into digital data that is processed by a computer and reproduces the data to the original data to be displayed on a monitor in a format that is usable by a computer user. The codec compresses a larger size file such as a motion picture file into small size and decompresses the file to its original size. Compressing a file into small size is referred to as “encoding” and decompressing the file back to its original size is referred to as “decoding”.

A multi-codec is a codec which encodes or decodes videos of various formats. For example, the multi-codec may support formats such as MPEG-2, MPEG-4, H.264, H.263, and VC-1.

However, the multi-codec processes one audio or video file at a time. Therefore, if several video files are input, the multi-codec encodes or decodes one video file and then encodes or decodes the next video file. Accordingly, if two video files are concurrently input, the multi-codes waits until one video file is completely processed and then processes the other video file.

Accordingly, there is a need for a video processing apparatus and method capable of encoding or decoding input videos concurrently.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

One or more exemplary embodiments of the present invention provide a video processing apparatus which determines a decoding order for decoding each of a plurality of videos, which are concurrently input, consecutively as much as a predetermined amount, and decodes the videos as much as the predetermined amount consecutively in the determined decoding order.

One or more exemplary embodiments of the present invention also provide a video processing apparatus which determines an order for encoding or decoding each of a plurality of videos, which are concurrently input, consecutively as much as a predetermined amount and encodes or decodes the vides as much as the predetermined amount consecutively in the determined order.

According to an aspect of the present invention, a video processing apparatus includes a scheduler which determines a decoding order for decoding each of a plurality of videos which are concurrently input, consecutively as much as a predetermined amount, and a multi-codec which decodes each of the videos as much as the predetermined amount consecutively in the decoding order determined by the scheduler.

The multi-codec may decode each of the videos as much as the predetermined amount in the decoding order determined by the scheduler, thereby decoding the plurality of videos concurrently.

At least two of the plurality of input videos may be encoded in different formats.

The predetermined amount may correspond to one frame.

The video processing apparatus may further include a memory which stores the plurality of input videos and videos which are processed by the multi-codec.

The scheduler may schedule a decoding order of each of the plurality of videos stored in the memory in the unit of frame and output a request for decoding for each of the videos to the multi-codec in the decoding order.

The multi-codec may decode the video corresponding to the request for decoding in the unit of frame to decode the videos stored in the memory concurrently, and may store the decoded video to the memory.

The scheduler may allocate virtual channels to the plurality of videos stored in the memory and determine a decoding order of the virtual channels.

The video processing apparatus may further include at least one physical channel which connects the scheduler to the multi-codec, and the scheduler may allocate one of the virtual channels to the at least one physical channel in the decoding order, and may output the request for decoding for a video corresponding to one of the virtual channels to the multi-codec through the allocated physical channel.

The request for decoding may include at least one of virtual channel information, an address of the video corresponding to the request for decoding on the memory, and size information of the video corresponding to the request for decoding.

The virtual channel information may includes at least one of a virtual channel identification number and a codec type.

According to another aspect of the present invention, a display apparatus includes the video processing apparatus described above.

According to still another aspect of the present invention, a video processing method includes determining a decoding order for decoding each of a plurality of videos which are concurrently input consecutively as much as a predetermined amount, and decoding the videos as much as the predetermined amount consecutively in the decoding order determined by the scheduler.

The decoding operation may decode each of the videos as much as the predetermined amount in the determined decoding order, thereby decoding the plurality of videos concurrently.

At least two of the plurality of input videos may be encoded in different formats.

The predetermined amount may correspond to one frame.

The video processing method may further include storing the plurality of input videos to the memory.

The video processing method may further include outputting a request for decoding for each of the videos in the decoding order to the multi-codec, and the determining operation may schedule the decoding order of each of the plurality of videos stored in the memory in the unit of frame.

The video processing method may further include storing the decoded video to the memory, and the decoding operation may decode a video corresponding to the request for decoding in the unit of frame to decode the videos stored in the memory concurrently.

The video processing method may further include allocating virtual channels to the plurality of videos stored in the memory, and the determining operation may determine a decoding order of the virtual channels.

The video processing method may further include allocating one of the virtual channels to one of at least one physical channel which connects a scheduler to a multi-codec in the decoding order, and outputting a request for decoding for a video corresponding to one of the virtual channels to the multi-codec through the allocated physical channel.

The request for decoding may include at least one of virtual channel information, an address of the video corresponding to the request for decoding on the memory, and size information of the video corresponding to the request for decoding.

The virtual channel information may include at least one of a virtual channel identification number and a codec type.

According to another aspect of the present invention, a computer readable recording medium records a computer program to perform the video processing method.

According to another aspect of the present invention, a video processing apparatus includes a scheduler which determines an order for repeatedly encoding or decoding each of a plurality of videos which are concurrently input, consecutively as much as a predetermined amount, and a multi-codec which encodes or decodes the videos as much as the predetermined amount consecutively in the order determined by the scheduler.

### BRIEF DESCRIPTION OF THE DRAWINGS

The present invention will become apparent and more readily appreciated from the following description of the exemplary embodiments, with reference to the accompanying drawings, in which:

FIG. 1 is a block diagram illustrating a video processing apparatus according to an exemplary embodiment of the present invention;

FIGS. 2A and 2B illustrate flowcharts of a video processing method according to an exemplary embodiment of the present invention;

FIGS. 3A to 3F are views conceptually illustrating a process of decoding a plurality of videos concurrently according to an exemplary embodiment of the present invention;

FIG. 4 is a view illustrating data included in a request for decoding according to an exemplary embodiment of the present invention;

FIG. 5 is a view illustrating data included virtual channel information according to an exemplary embodiment of the present invention;

FIG. 6 is a block diagram illustrating a television (TV) including a video processing apparatus according to an exemplary embodiment of the present invention; and

FIG. 7 is a view illustrating a TV receiving two videos concurrently and displaying the two videos in a picture-in-picture (PIP) form according to an exemplary embodiment of the present invention.

### DETAILED DESCRIPTION OF EXEMPLARY EMBODIMENTS

Exemplary embodiments of the present invention are described in greater detail below with reference to the accompanying drawings.

In the following description, like drawing reference numerals are used for like elements, even in different drawings. The matters defined in the description, such as detailed construction and elements, are provided to assist in a comprehensive understanding of the invention. However, the exemplary embodiments of the present invention can be practiced without those specifically defined matters. Also, well-known functions or constructions are not described in detail since they would obscure the invention with unnecessary detail.

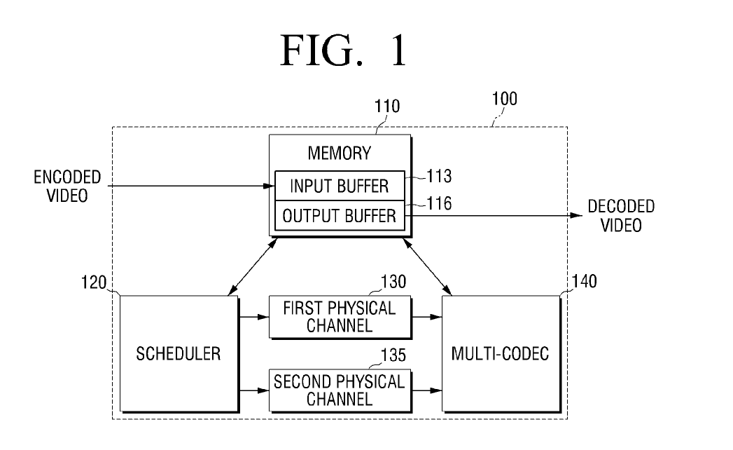

FIG. 1 illustrates a video processing apparatus according to an exemplary embodiment of the present invention. As shown in FIG. 1, a video processing apparatus 100 includes a memory 110, a scheduler 120, a first physical channel 130, a second physical channel 135, and a multi-codec 140.

The memory 110 may be a common memory shared by the scheduler 120 and the multi-codec 140. The memory 110 stores a plurality of videos which are concurrently input and also stores videos which are processed by the multi-codec 140.

More specifically, the memory 110 includes an input buffer 113 and an output buffer 116. The input buffer 113 stores input videos and the output buffer 116 stores videos which are processed by the multi-codec 140.

The scheduler 120 determines a decoding order for alternatively decoding the plurality of input videos in a unit of a predetermined amount. At least two of the plurality of videos may be encoded in different formats. For example, the videos may be encoded in one of formats including MPEG-2, MPEG-4, H.264 VC-1, and H.263. The predetermined amount refers to an amount by which the video is decoded at a time by the multi-codec 140. For example, the predetermined amount may correspond to one or more frames.

More specifically, the scheduler 120 schedules the decoding order of each of the plurality of videos stored in the memory 110 in the unit of a frame.

Scheduling refers to a process of determining an order for decoding each frame of the plurality of videos. A general scheduling algorithm is used to determine the order. For example, the scheduling algorithm may include priority scheduling, deadline scheduling, round robin scheduling, and shortest job first (SJF) scheduling algorithms.

The scheduler 120 may allocate virtual channels to the plurality of videos stored in the memory 110, and may schedule a decoding order of the virtual channels. The virtual channel refers to a channel which is arbitrarily allocated to each of the plurality of videos to transmit a request for decoding through a limited number of physical channels. The virtual channels may be generated to correspond to the number of videos. A virtual channel may be allocated to a corresponding video.

For example, if a first video encoded in the H.264 format, a second video encoded in MPEG-2 format, and a third video encoded in MPEG-4 format are concurrently input, three virtual channels are generated. A first virtual channel is allocated to the first video, a second virtual channel is allocated to the second video, and a third virtual channel is allocated to the third video.

The scheduler 120 determines the decoding order of the videos corresponding to the virtual channels according to the scheduling algorithm. For example, if the priority scheduling algorithm is used, priorities are allocated to the virtual channels. That is, the scheduler 120 determines the decoding order in a manner that allocates the first priority to the first virtual channel, the second priority to the second virtual channel, and the third priority to the third virtual channel.

The scheduler 120 outputs a request for decoding for each of the videos to the multi-codec 140 in the decoding order. More specifically, the scheduler 120 allocates one of the virtual channels to either one of the first, second physical channels 130, 135 in the decoding order. The scheduler 120 outputs the request for decoding of the video corresponding to the virtual channel to the multi-codec 140 through the allocated physical channel.

The request for decoding may be a message to request one frame of a specific video to be decoded. The request for decoding includes at least one of virtual channel information, an address of the video corresponding to the request for decoding in the memory 110, and size information of the video corresponding to the request for decoding.

The virtual channel information is provided for the multi-codec 140 to identify the virtual channel and to be aware of the format of the video corresponding to the virtual channel. The virtual channel information includes at least one of a virtual channel identification (ID) number and a codec type. The codec type indicates an encoding format and may be one of MPEG-2, MPEG-4, H.264 VC-1, and H.263.

The first and the second physical channels 130, 135 serve as a path for the scheduler 120 to output the request for decoding to the multi-codec 140. Although only two physical channels are illustrated in this exemplary embodiment, the number of physical channels is not limited. For example, the number of physical channels may be one, three, or more.

The multi-codec 140 decodes the video encoded in various formats. For example, the multi-codec 140 may support MPEG-2, MPEG-4, H.264 VC-1, and/or H.263 formats. Also, the multi-codec 140 alternatively decodes each of the videos in the units of the predetermined amount in the decoding order determined by the scheduler 120. Accordingly, the multi-codec 140 may decode the plurality of videos concurrently rather than completely decoding each video before decoding the other videos.

More specifically, the multi-codec 140 decodes the video corresponding to the request for decoding in the predetermined unit of frame in order of receiving the request for decoding from the scheduler 120. As described above, since the request for decoding contains information about the address of the corresponding video stored in the memory 110, the multi-codec 140 decodes one frame of the video stored in the corresponding address of the memory 110 with reference to the address contained in the request for decoding.

Further, the multi-codec 140 stores the decoded video in the memory 110.

As described above, since the multi-codec 140 decodes the plurality of videos frame by frame in the decoding order determined by the scheduler 120, the plurality of input videos may be decoded concurrently.

For example, in the case that the multi-codec 140 has a capability of decoding 60 frames of each of three videos per one second, if three videos are concurrently input to the video processing apparatus 100, the video processing apparatus 100 can decode the three videos concurrently and output three decoded videos of 60 Hz concurrently.

Accordingly, if the user inputs three encoded videos, the user may concurrently watch three decoded videos in real time without having to waiting until the videos are completely decoded one by one.

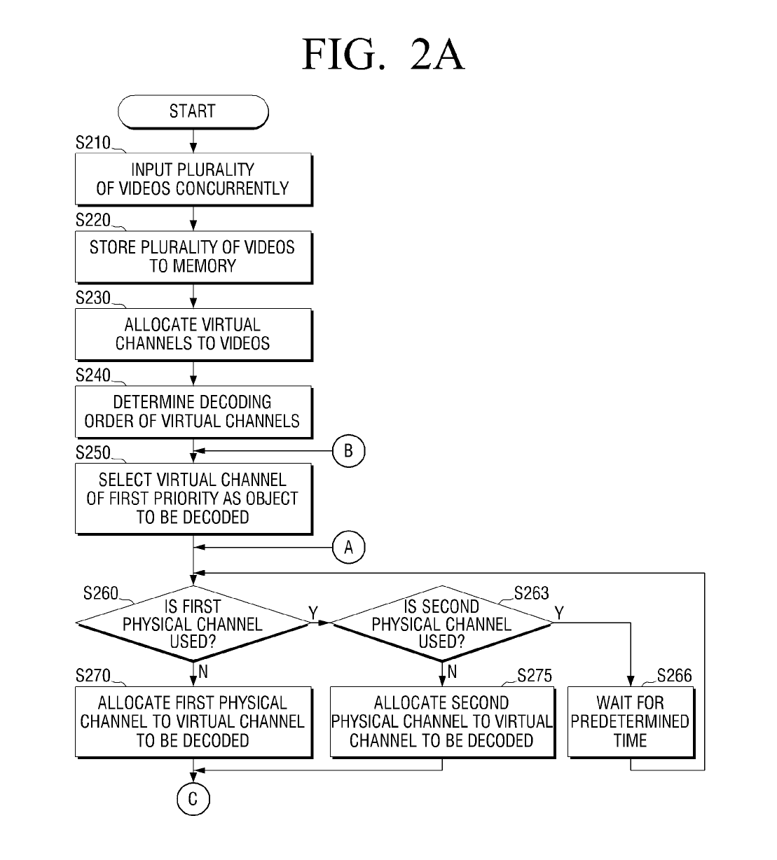

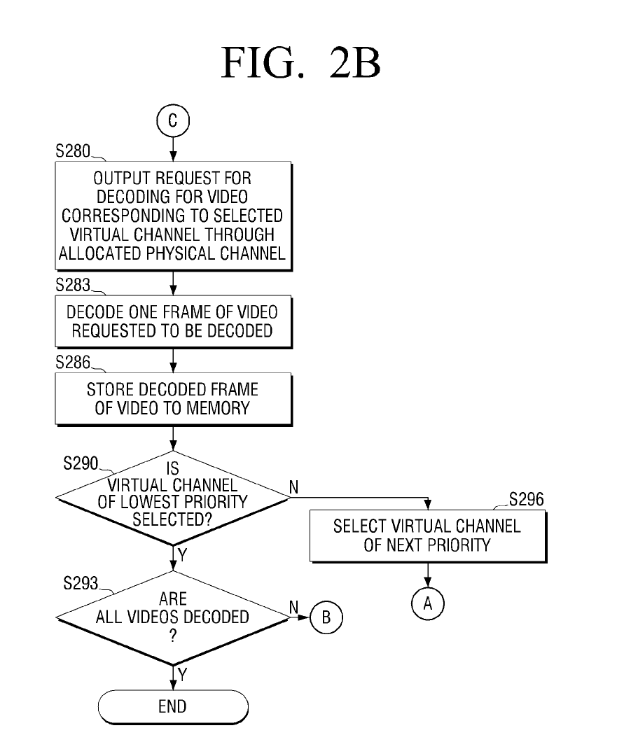

A video processing method is described below with reference to FIGS. 2A and 2B. FIGS. 2A and 2B are flowcharts illustrating a video processing method according to an exemplary embodiment of the present invention.

The video processing apparatus 100 receives a plurality of videos (S210). For example, the video processing apparatus 100 may concurrently receive a TV broadcast program and a motion picture which is stored to a storage medium. Also, the video processing apparatus 100 may receive videos generated by a plurality of closed-circuit television (CCTV) cameras.

The video processing apparatus 100 stores the plurality of videos in the input buffer 113 of the memory 110 (S220). The video processing apparatus 100 allocates virtual channels to the respective videos stored in the memory 110 (S230).

Then, the video processing apparatus 100 determines a decoding order for the videos corresponding to the virtual channels according to a scheduling algorithm (S240). The decoding order refers to an order which is scheduled to decode each of the plurality of videos consecutively in a unit of a predetermined amount. The predetermined amount refers to a unit by which the video is decoded at a time by the multi-codec 140. For example, the predetermined amount may be one frame.

The video processing apparatus 100 selects a virtual channel of the first priority as an object to be decoded (S250). For example, a priority scheduling algorithm is used, according to which each virtual channel is selected as an object to be decoded according to the priority.

Next, the video processing apparatus 100 determines whether the physical channel 130 is being used (S260). If it is determined that the first physical channel 130 is not used (S260-N), the video processing apparatus 100 allocates the first physical channel 130 to the virtual channel of the first priority which is selected as an object to be decoded (S270).

On the other hand, if it is determined that the first physical channel 130 is being used (S260-Y), the video processing apparatus 100 determines whether the second physical channel 135 is being used (S263). If it is determined that the second physical channel 135 is not used (S263-N), the video processing apparatus 100 allocates the second physical channel 135 to the virtual channel of the first priority which is selected an object to be decoded (S275).

On the other hand, if it is determined that the second physical channel 135 is being used (S263-Y), the video processing apparatus 100 waits for a predetermined time (S266) and determines again whether the first physical channel 130 is being used (S260).

Through operations 5260, S263, 266, 5270, and 5275, one of the virtual channels is allocated to one of the physical channels according to the decoding order.

The video processing apparatus 100 then outputs a request for decoding for the video corresponding to the selected virtual channel to the multi-codec 140 through the allocated physical channel (S280).

The video processing apparatus 100 decodes one frame of the video corresponding to the request for decoding (S283). More specifically, since the request for decoding contains information of the address of the video corresponding to the request for decoding in the memory 110, the multi-codec 140 of the video processing apparatus 100 decodes one frame of the video stored in the corresponding address of the memory 110 with reference to the address information contained in the request for decoding.

The video processing apparatus 100 stores the decoded frame of the video in the output buffer 116 of the memory 110 (S286).

The video processing apparatus 100 then determines whether the virtual channel of lowest priority is selected as an object to be decoded (S290). If it is determined that the virtual channel of the lowest priority is not selected as an object to be decoded (S290-N), the video processing apparatus 100 selects the virtual channel of the next priority as an object to be decoded (S296). With respect to the virtual channel selected as an object to be decoded, the video processing apparatus 100 resumes operation S260.

On the other hand, if it is determined that the virtual channel of the lowest priority is selected as an object to be decoded (S290-Y), the video processing apparatus 100 determines whether all of the videos are decoded (S293).

If it is determined that all of the videos are not decoded (S293-N), the video processing apparatus 100 resumes operation S250. If it is determined that all of the videos are decoded (S293-Y), the video processing apparatus 100 finishes the decoding operation.

As described above, since the video processing apparatus 100 decodes the plurality of videos in the unit of a frame in the decoding order which is determined by the scheduler 120, the plurality of input videos are concurrently decoded.

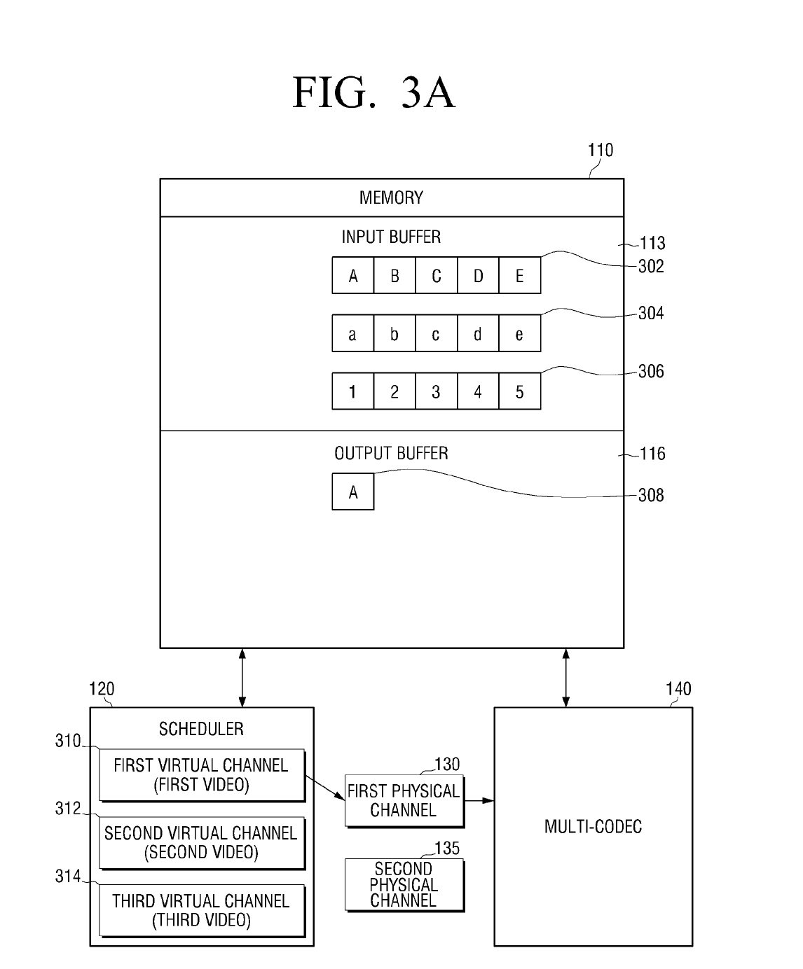

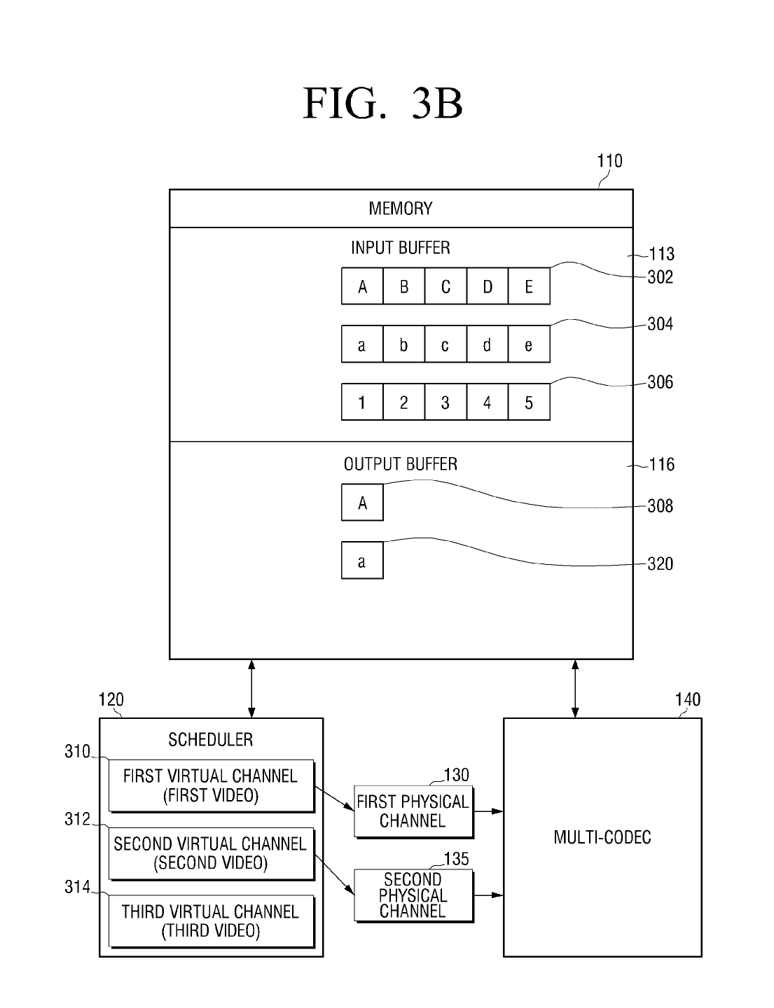

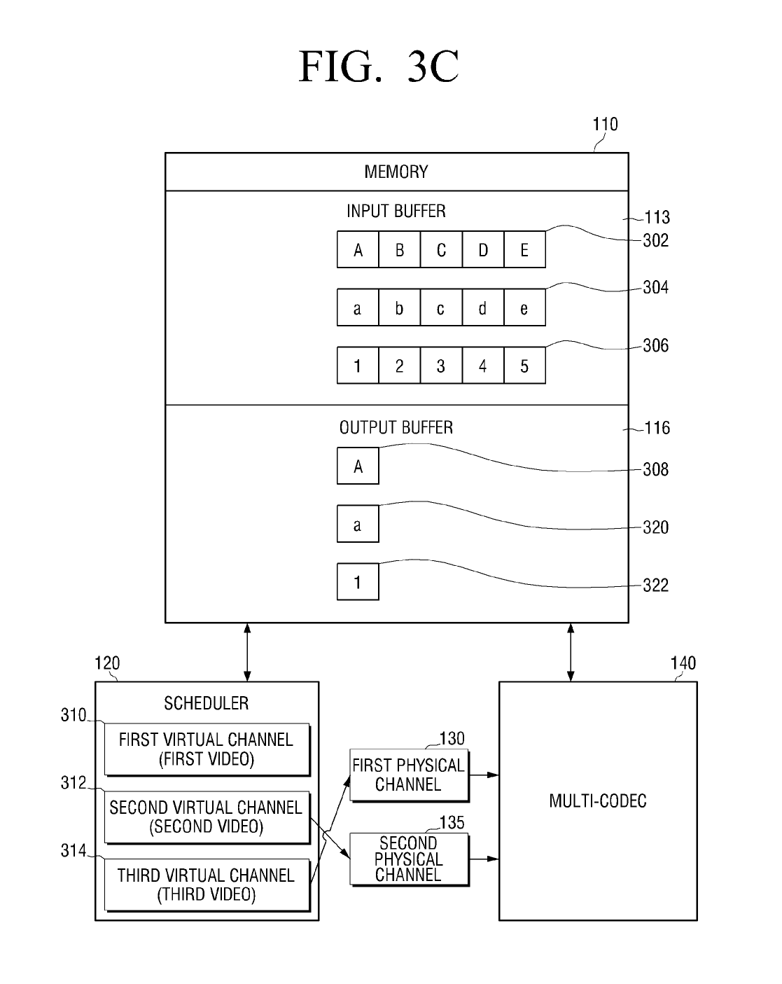

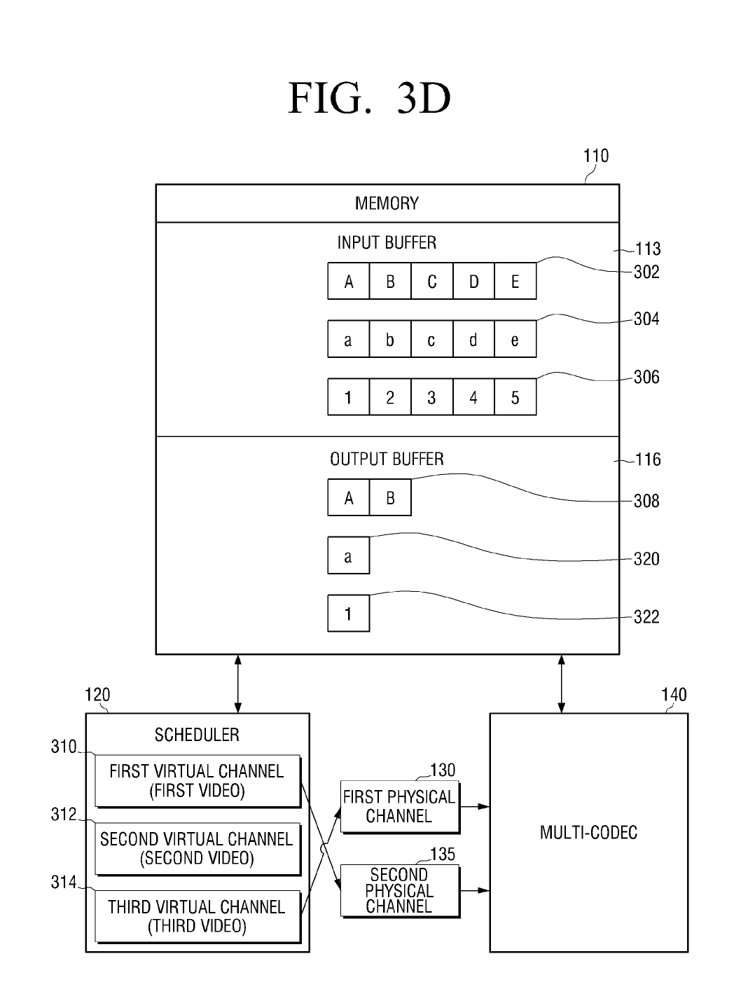

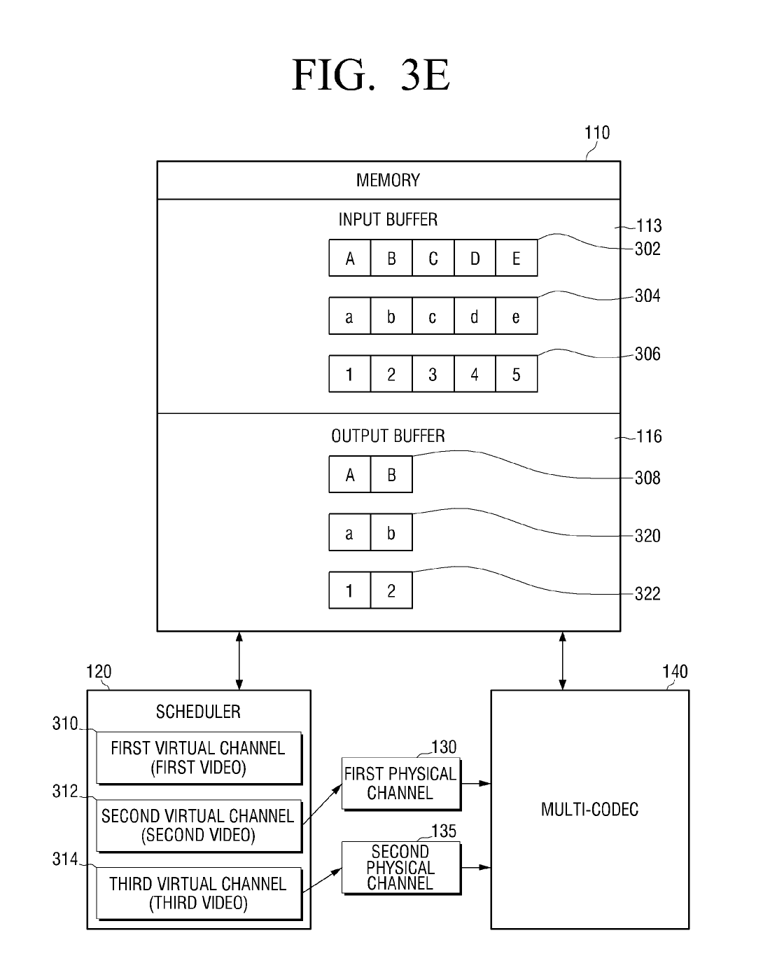

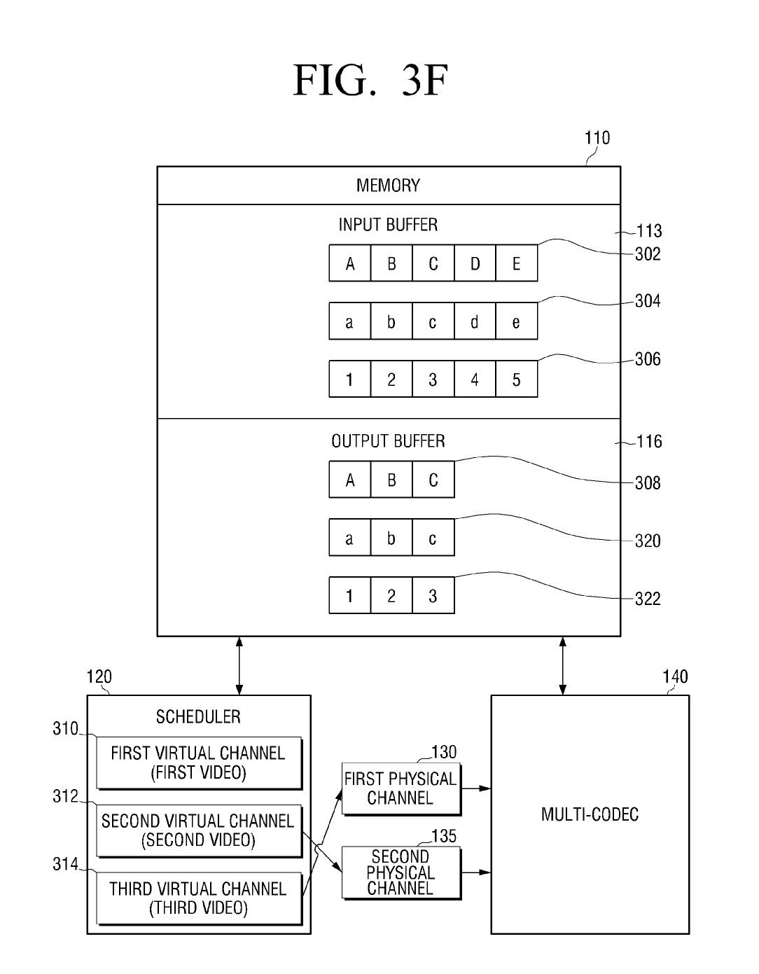

A process of decoding a plurality of videos concurrently is described below with reference to FIGS. 3A to 3F. FIGS. 3A to 3F are views conceptually illustrating a process of decoding a plurality of videos concurrently.

FIGS. 3A to 3F illustrate three videos which are stored to the memory 110 of the video processing apparatus 100 and three corresponding virtual channels which are generated by the scheduler 120.

Since FIGS. 3A to 3F illustrate three videos and three virtual channels in a similar structure, description of the same parts in each drawing is omitted.

As shown in FIG. 3A, the input buffer 113 of the memory 110 stores a first video 302 encoded in H.264, a second video 304 encoded in MPEG-2, and the third video 306 encoded in MPEG-4. Referring to FIG. 3A, the first video 302 contains first through fifth frames A, B, C, D, E, the second video 304 contains first through fifth frames a, b, c, d, e, and the third video 306 contains first through fifth frames 1, 2, 3, 4, 5.

The output buffer 116 stores the decoded frame A of the first decoded video 308.

The scheduler 120 generates a first virtual channel 310 for the first video, a second virtual channel 312 for the second video, and a third virtual channel 314 for the third video. As illustrated, the first virtual channel 310 is allocated to the first physical channel 130.

That is, in FIG. 3A, the scheduler 120 outputs a request for decoding for the frame A of the first video 302 through the first physical channel 130 with the first virtual channel 310 allocated to the first physical channel 130. Accordingly, the multi-codec 140 decodes the frame A of the first video 302 of the input buffer 113 and stores the decoded frame A to the output buffer 116.

In this example, the first virtual channel 310 has the highest priority, the second virtual channel 312 has the next priority, and the third virtual channel 314 has the lowest priority ranking. Accordingly, the frame ‘a’ of the second video is decoded in the next phase, which is illustrated in FIG. 3B.

FIG. 3B illustrates the state in which the frame ‘a’ of the second video 304 is decoded. As shown in FIG. 3B, the second virtual channel 312 is allocated to the second physical channel 135 since the first physical channel 130 is allocated to the first virtual channel 310. Accordingly, the scheduler 120 outputs a request for decoding the second video through the second physical channel 135. The multi-codec 140 decodes the frame ‘a’ of the second video 304 stored in the input buffer 113 and stores the decoded frame ‘a’ of the decoded second video 320 to the output buffer 116.

The third video 306 of the third virtual channel 314 which corresponds to the next priority is then decoded as illustrated in FIG. 3C.

FIG. 3C illustrates the state in which the frame 1 of the third video 306 is decoded. If the first and the second physical channels 130 and 135 are currently allocated, the scheduler 120 waits until the request for decoding for the first virtual channel 310 is completed. Then, as shown in FIG. 3C, the scheduler 120 allocates the first physical channel 130 to the third virtual channel 314 when the request for decoding for the first virtual channel 310 is completed. Accordingly, the scheduler 120 outputs a request for decoding for the third video through the first physical channel 130. The multi codec 140 decodes the frame ‘1’ of the third video 306 stored in the input buffer 113 and stores the decoded frame ‘1’ of the third decoded video 322 to the output buffer 116.

If each of the virtual channels is decoded once through the above-described operations in an order of priority from the highest priority to the lowest priority, the first virtual channel 310 is decoded again as illustrated in FIG. 3D.

FIG. 3D illustrates the state in which the frame B of the first video 302 is decoded. If the first physical channel 130 and the second physical channel 135 are currently allocated, the scheduler 120 waits until the request for decoding for the second virtual channel 312 is completed. If the request for decoding for the second virtual channel 312 is completed, the scheduler 120 allocates the second physical channel 135 to the first virtual channel 310. Accordingly, the scheduler 120 outputs a request for decoding the first video 302 through the second physical channel 135. The multi-codec 140 decodes the frame B of the first video 302 stored in the input buffer 113 and stores the decoded frame ‘B’ of the first decoded video 308 to the output buffer 116.

In a similar manner, as shown in FIG. 3E, the multi-codec 140 decodes the second frames of the second video 304 and the third video 306 and stores the decoded frames to the output buffer 116. Then, as shown in FIG. 3F, the multi-codec 140 decodes the third frames corresponding to each input video and stores the decoded frames to the output buffer 116.

As shown in FIGS. 3A to 3F, upon receiving a request for decoding, the multi-codec 140 decodes the video corresponding to the request for decoding in the unit of a frame in the determined order.

Through the above-described operations, the first video 302, the second video 304, and the third video 306 of different formats, which are concurrently input, are decoded. As described above, the videos are decoded in the unit of frame. If the multi-codec 140 decodes 3*60 frames per second, the video processing apparatus 100 decodes the three videos of 60 Hz, which are concurrently input, and outputs the decoded videos. Accordingly, the user may input the first video 302, the second video 304, and the third video 306 concurrently and watch the videos on a TV concurrently.

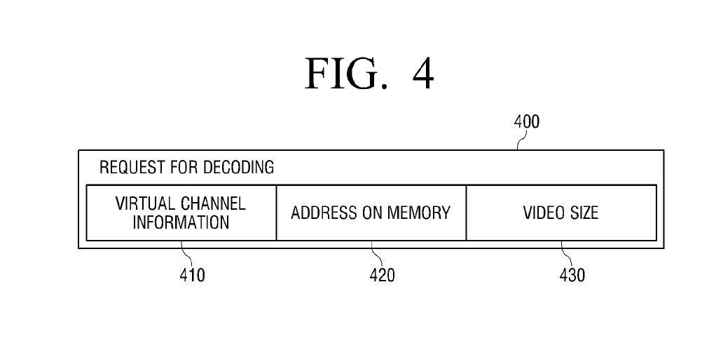

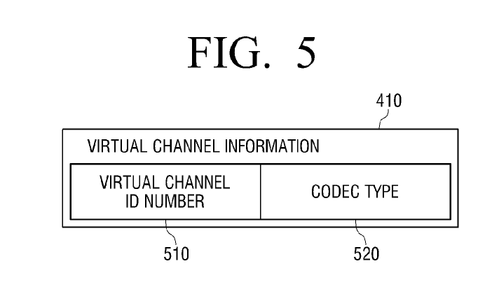

Hereinafter, with reference to FIGS. 4 and 5, the structure of a request for decoding and virtual channel information are described.

FIG. 4 illustrates the structure of data contained in a request 400 for decoding according to an exemplary embodiment of the present invention. The request 400 for decoding is a message to request one frame of a specific video to be decoded. As shown in FIG. 4, the request 400 for decoding includes virtual channel information 410, address 420 information of the video corresponding to the request for decoding in the memory 110, and video size information 430.

The address information 420 of the video in the memory 110 is an address value indicating which part of the memory 110 stores the video corresponding to the request for decoding. Based on the address information 420, the multi-codec 140 finds the video to be decoded in the memory 110.

The video size information 430 is a value indicating the entire size of the video. The video size information 430 is used for estimating the time needed for decoding, or determining whether the decoding is completed.

FIG. 5 illustrates data contained in the virtual channel information 410 according to an exemplary embodiment of the present invention. The virtual channel information 410 is provided for the multi-codec 140 to identify the virtual channel and the format of the video corresponding to the virtual channel. Accordingly, as shown in FIG. 5, the virtual channel information 410 includes at least one of a virtual channel ID 510 number and a codec type 520.

The codec type 520 refers to an encoding type and may be one of MPEG-2, MPEG-4, H.264, VC-1, and H.263. The virtual channel ID number 510 is used for identifying the virtual channel and may be expressed by Arabic numerals.

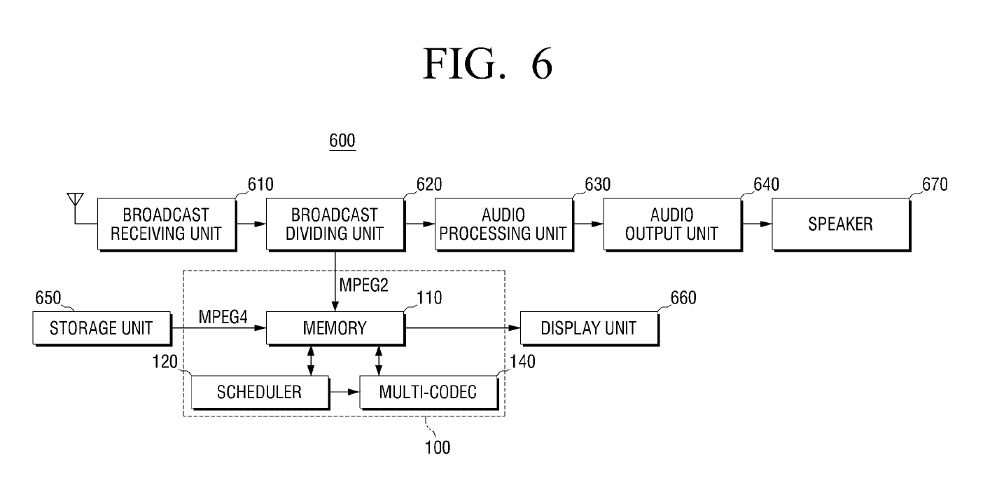

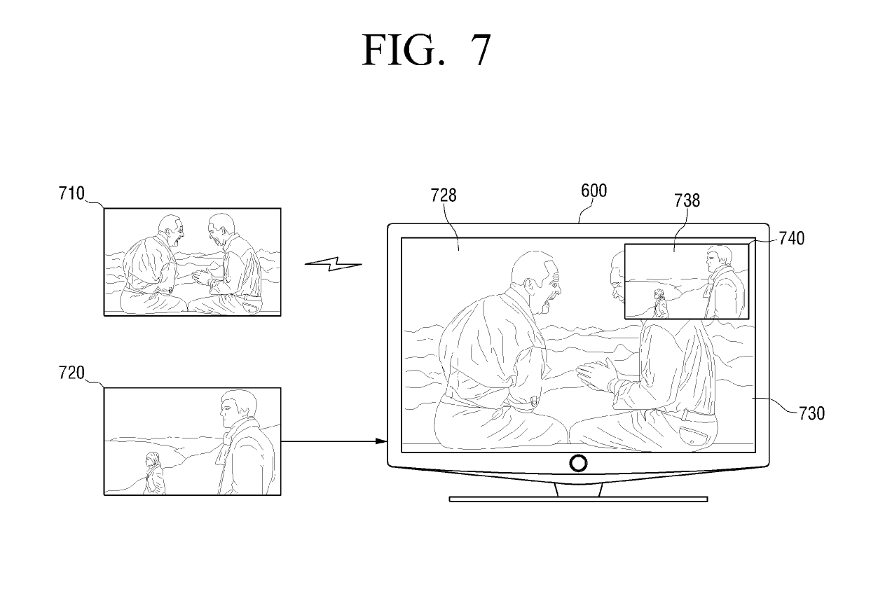

Hereinafter, a TV 600, which includes the video processing apparatus 100, is described with reference to FIGS. 6 and 7. FIG. 6 illustrates the TV in which a video processing apparatus according to an exemplary embodiment of the present invention is mounted.

As shown in FIG. 6, the TV 600 includes a broadcast receiving unit 610, a broadcast dividing unit 620, an audio processing unit 630, an audio output unit 640, a storage unit 650, a video processing apparatus 100, and a display unit 660.

The broadcast receiving unit 610 receives a broadcast from a broadcasting station or a satellite in a wire or wireless manner and tunes to the broadcast.

The broadcast dividing unit 620 divides the received broadcast signal into an audio signal and a video signal. The audio signal is output to the audio processing unit 630 and the video signal is output to the video processing apparatus 100. The video signal is encoded in MPEG-2.

The audio processing unit 630 performs signal-processing such as audio decoding and noise removal with respect to the audio signal. The audio processing unit 630 outputs the processed audio signal to the audio output unit 640.

The audio output unit 640 outputs the audio output from the audio processing unit 630 through a speaker 670.

The storage unit 650 stores a recorded motion picture. For example, the storage unit 650 may store the motion picture encoded in MPEG-4. The storage unit 650 outputs the motion picture encoded in MPEG-4 to the memory 110 of the video processing apparatus 100.

The video processing apparatus 100 receives the broadcast video encoded in MPEG-2 from the broadcast dividing unit 620 and the motion picture video encoded in MPEG-4 from the storage unit 650. The video processing apparatus 100 decodes the input videos concurrently, as described above, and outputs the decoded videos to the display unit 660.

Accordingly, the display unit 660 displays the received broadcast and the motion picture concurrently, as described below with reference to FIG. 7.

FIG. 7 illustrates the TV 600 which receives first and second videos 710, 720 concurrently and displays the first and second videos 710, 720 in a PIP form.

As shown in FIG. 7, the TV 600, which includes the video processing apparatus 100 according to an exemplary embodiment of the present invention, concurrently receives the first video 710, such as a broadcast, encoded and stored in MPEG-2 and the second video 720, such as a motion picture, encoded and stored in MPEG-4, and decodes the first and second videos. The TV 600 displays a broadcast 728 decoded from MPEG-2 on a main screen 730 and displays a motion picture 728 decoded from MPEG-4 on a PIP screen 740, concurrently.

In this exemplary embodiment, the TV 600 including the video processing apparatus 100 provides the PIP function. However, the present invention may be applied to any apparatus if the apparatus receives a plurality of videos concurrently. For example, the present invention may be applied to a TV 600 which provides a video conference function or receives videos from a plurality of CCTVs.

Also, the multi-codec 140 may encode the videos, so the present invention may be applied to the case where the videos are encoded.

Also, although the video processing apparatus 100 is embodied in the TV in this exemplary embodiment, the video processing apparatus 100 may be embodied in any other display apparatuses.

Further, the present invention may be applied to a computer-readable recording medium which records a computer program capable of executing the video processing method according to an exemplary embodiment of the present invention. Also, the present invention may be realized as a computer-readable code which is recorded on a computer-readable recording medium. The computer-readable recording medium may be any data storage device which is readable by the computer and stores data. For example, the computer-readable recording medium includes a ROM, a RAM, a CD-ROM, a magnetic tape, a floppy disk, an optical disk, and a hard disk drive. The computer-readable code or program which is recorded on the computer-readable recording medium may be transmitted through a network connected among the computers.

As described above, according to exemplary embodiments of the present invention, the video processing apparatus 100 determines a decoding order for decoding each of a plurality of input videos consecutively in a unit of a predetermined amount and decodes the videos in the determined order in the unit of the predetermined amount, thereby decoding the plurality of videos concurrently. Accordingly, the user may view the plurality of videos of different formats concurrently.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A video processing apparatus comprising:
a scheduler which determines a decoding order for alternatively decoding each of a plurality of videos which are concurrently input, in a unit of a predetermined amount; and
a multi-codec which alternatively decodes each of the videos in the unit of the predetermined amount in the decoding order determined by the scheduler.

2. The video processing apparatus as claimed in claim 1, wherein the multi-codec alternately decodes each of the videos in the unit of the predetermined amount in the decoding order determined by the scheduler, so that the unit of the predetermined amount of each of the videos is decoded before all of the units of the videos are completely decoded.

3. The video processing apparatus as claimed in claim 1, wherein at least two of the input videos are encoded in different formats.

4. The video processing apparatus as claimed in claim 1, wherein the predetermined amount corresponds to one frame.

5. The video processing apparatus as claimed in claim 1, further comprising a memory which stores the videos which are input and videos which are decoded by the multi-codec.

6. The video processing apparatus as claimed in claim 5, wherein the scheduler schedules the decoding order for decoding each of the videos stored in the memory in the unit of the predetermined amount and outputs a request for decoding for each of the videos to the multi-codec in the decoding order.

7. The video processing apparatus as claimed in claim 6, wherein the multi-codec decodes the video corresponding to the request for decoding in the unit of the predetermined amount to decode the videos stored in the memory concurrently, and stores the decoded units of the predetermined amount of the video in the memory.

8. The video processing apparatus as claimed in claim 5, wherein the scheduler allocates virtual channels to the videos stored in the memory and determines a decoding order for the virtual channels.

9. The video processing apparatus as claimed in claim 8, further comprising at least one physical channel which connects the scheduler to the multi-codec,
wherein the scheduler allocates one of the virtual channels to one of the at least one physical channel in the decoding order, and outputs a request for decoding for a video corresponding to one of the virtual channels to the multi-codec through the allocated physical channel.

10. The video processing apparatus as claimed in claim 9, wherein the request for decoding comprises at least one of virtual channel information, an address of the video corresponding to the request for decoding in the memory, and size information of the video corresponding to the request for decoding.

11. The video processing apparatus as claimed in claim 10, wherein the virtual channel information comprises at least one of a virtual channel identification number and a codec type.

12. A display apparatus comprising the video processing apparatus of claim 1.

13. A video processing method comprising:
determining a decoding order for alternatively decoding each of a plurality of videos which are concurrently input, in a unit of a predetermined amount; and
alternatively decoding the videos in the unit of the predetermined amount in the determined decoding order.

14. The video processing method as claimed in claim 13, wherein the alternatively decoding comprises alternatively decoding each of the videos in the unit of the predetermined amount in the determined decoding order, so that the plurality of input videos is decoded concurrently.

15. The video processing method as claimed in claim 13, wherein at least two of the videos are encoded in different formats.

16. The video processing method as claimed in claim 13, wherein the predetermined amount corresponds to one frame.

17. The video processing method as claimed in claim 13, further comprising storing the videos in a memory.

18. The video processing method as claimed in claim 17, further comprising:
generating a request for decoding each of the videos in the decoding order to a multi-codec, and
scheduling the decoding order of each of the videos stored in the memory in the unit of the predetermined amount.

19. The video processing method as claimed in claim 18, further comprising:
decoding a video corresponding to the request for decoding in the unit of the predetermined amount to decode the videos stored in the memory so that the unit of the predetermined amount of each of the videos is decoded before all of the units of the videos are completely decoded; and
storing the decoded units of the predetermined amount of the video in the memory.

20. The video processing method as claimed in claim 17, further comprising:
allocating virtual channels to the videos stored in the memory; and
determining the decoding order of the virtual channels.

21. The video processing method as claimed in claim 20, further comprising:
allocating one of the virtual channels to at least one physical channel, which connects a scheduler to a multi-codec, in the decoding order; and
outputting a request for decoding a video corresponding to one of the virtual channels to the multi-codec through the allocated physical channel.

22. The video processing method as claimed in claim 21, wherein the request for decoding comprises at least one of virtual channel information, an address of the video corresponding to the request for decoding in the memory, and size information of the video corresponding to the request for decoding.

23. The video processing method as claimed in claim 22, wherein the virtual channel information comprises at least one of a virtual channel identification number and a codec type.

24. A computer-readable recording medium which stores a computer program, which, when executed by a computer, causes the computer to perform the video processing method of claim 13.

25. A video processing apparatus comprising:
a scheduler which determines an order for encoding or decoding each of a plurality of videos, which is concurrently input, alternatively in a unit of a predetermined amount; and
a multi-codec which alternatively encodes or alternatively decodes the videos in the unit of the predetermined amount in the decoding order determined by the scheduler.

26. A method comprising:
concurrently receiving input videos;
assigning priority levels to the input videos based on a predetermined criteria;
determining an order for alternatively decoding or encoding a predetermined amount of the input videos based on the assigned priority;
alternatively decoding or encoding the predetermined amounts of the input videos repeatedly in the determined order; and
outputting the decoded or encoded videos concurrently.

27. The method of claim 26, wherein the predetermined amount comprises a frame, the method further comprising:
receiving a first video of a first format;
receiving a second video of a second format, which is different from the first format;
assigning a higher priority level to the first video and a lower priority level to the second video;
initiating decoding or encoding of the first video prior to initiating decoding or encoding of the second video; and
processing each frame of the first video in alternation with each frame of the second video.
